(19) United States
(12) Patent Application Publication
(10) Pub. No.: US 2017/0262939 A1
(43) Pub. Date: Sep. 14, 2017

(54) SPONSORSHIP MANAGEMENT METHOD AND SYSTEM

(71) Applicant: LYF APP PTY LTD, Melbourne, Victoria (AU)

(72) Inventors: Daniel Millin, South Melbourne, Victoria (AU); Karen Crawford, Strathmore, Victoria (AU); Martin Jonas, Caroline Springs, Victoria (AU)

(21) Appl. No.: 15/504,754

(22) PCT Filed: Aug. 19, 2015
(86) PCT No.: PCT/AU2015/000500

§ 371 Date: Feb. 17, 2017

Related U.S. Application Data
(60) Provisional application No. 62/038,906, filed on Aug. 19, 2014.

(51) Int. Cl. G06Q 40/06; G06F 7/02

(52) U.S. Cl. CPC G06Q 40/06; G06F 7/026

(57) ABSTRACT

A system for managing sponsorships. The system generates a compatibility score based on target information provided by a potential sponsor and information obtained from potential sponsorship candidate. The target information includes information on personal characteristics and project/event characteristics deemed desirable by a sponsor in a sponsorship candidate and/or event. The information obtained from the sponsorship candidates includes personal information relating to the candidate and information on projects/events associated with the candidate. The system then presents to the potential sponsorship candidate potential sponsors which have a compatibility score above a predetermined threshold i.e. presents a listing of potential sponsors which best match the user. The user may then elect to accept or reject sponsorship from the listed sponsors.

### RELATED APPLICATION

This application is based on and claims the benefit of the filing and priority dates of U.S. patent application No. 62/038,906 filed 19 Aug. 2014, the content of which as filed is incorporated herein by reference in its entirety.

### TECHNICAL FIELD

The present invention relates to a sponsorship management method and system, of particular but by no means exclusive application in controlling the accessing and deployment of sponsorship.

### BACKGROUND

Sponsorship is used by many companies and individuals as an expression of support of the endeavours of others, commonly of high profile elite in their chosen pursuits. For this reason the terms ‘sponsorship’ and ‘support’ are essentially interchangeable in this context, though the terms ‘sponsor’ and ‘sponsorship’ are generally used herein to denote a formalized level of support, typically involving the provision of some material assistance to the sponsored or supported party in furthering his or her endeavours.

Sport sponsorship is a typical example. For example, a prominent car driver may be sponsored or supported by a car company, or a famous sport player may be sponsored by a company that provides equipment or other goods associated (or desired to be associated with) that sport, in both cases involving generally involving payment (whether financial or in kind) to the sponsored/supported party. Such sponsorships result from negotiations between the sponsoring and sponsored parties. While some negotiations of this type may be simple and concluded promptly, others may be protracted even where the terms of the negotiation are common in the relevant area.

### SUMMARY OF THE INVENTION

According to first broad aspect of the invention, there is provided a system for managing sponsorship of users by sponsors, comprising:
a computing system comprising a user interface and a controller having a processor, an operating system and a memory;
wherein the processor is configured:
   to receive personal information pertaining to a user and associated with user identification information that identifies the user;
   to receive project information pertaining to a project that is associated with the user;
   to receive respective target user information indicative of personal characteristics deemed by one or more sponsors to be desirable in a sponsored user, the target user information being associated with respective sponsor identification information that identifies the respective sponsor;
   to receive respective target project information indicative of project characteristics deemed desirable in a sponsored project by the respective sponsors;
   to form respective comparisons by comparing the personal information and the project information with the respective target user information and target project information;
   to generate respective compatibility scores from the comparisons, the compatibility scores being indicative of how well matched are the project and the respective sponsorships;
   to compare the compatibility scores with a compatibility threshold;
   to present to the user the respective sponsor identification information associated with at least some of the compatibility scores that satisfy the compatibility threshold via the user interface for user selection or rejection; and
   to receive from the user either selection or rejection data, the selection data being indicative of at least one selected sponsor or sponsorship, the rejection data being indicative of rejection at least one rejected sponsor or sponsorship.

It will be appreciated that the terms ‘sponsorship’ and ‘sponsor’ used in describing the present invention are intended to embrace all arrangements and parties having the characteristics of ‘sponsorships’ and ‘sponsors’ respectively, however described.

It should be noted that the information used in forming the comparison and ultimately in the generation of a compatibility score may be in many forms, including simple numerical data (such as age, income, number of children, postcode, number of followers/supporters, number of projects or ‘journeys’, etc), text data (such as job title, project title, project/journey type or category, etc), more complex data (such as image or audio data if a user has uploaded such content) or derived data (obtained, for example, from an analysis of other data or from relationships between the user and other users and/or projects/journeys).

The compatibility threshold may be predefined or determined dynamically using algorithms applied to target and/or sponsor information.

In one example, the user may wish to attract the sponsorship of a particular party (whether a person or an organization) that the user, for example, has an interest in, favours or supports. To do so, the user might include, in his or her personal information or project information, text that identifies that party. Then, when the processor compares the personal information and the project information of the user with the target user information and target project information of the party identified by the user, and generates a compatibility score for that user, the appearance of the name of the party in the target user information and/or target project information may, in some implementations, be sufficient to result in a high compatibility score—such that the party is likely or certain to be amongst those whose sponsor identification information is presented to the user for selection by the user.

The system or the computing system may be distributed. The various components of the system may be accessible via a computer network such as the internet.

In one embodiment, the system is arranged: to present to the sponsors associated with the compatibility scores that satisfy the compatibility threshold at least some of the personal information and project information of the user in de-identified (or anonymized) form via the user interface for sponsor review, and upon receiving a sponsor rejection from one or more of the sponsors, to eliminate either the sponsor or the sponsorship of the sponsor from presentation to the user.

In one embodiment, the processor is configured to identify the at least one selected sponsor or sponsorship as a sponsor of the user only in response to receiving a user acceptance input from the respective sponsor.

In another embodiment, the processor is arranged, upon receiving the data indicative of at least one selected sponsor or sponsorship, to associate the at least one selected sponsor as a sponsor of the project of the user.

The system may be arranged: to receive the personal information from the user interface and to store the personal information in the memory in association with the user identification information; and to receive the project information from the user interface and either (i) to create the project and store the project information in the memory in association with the project (if the project had not previously been created), or (ii) to store the project information in the memory in association with the project (if the project had previously been created).

In one embodiment, the processor is configured:
to present a set of predefined project tags to the user via the user interface;
to receive from the user one or more selected project tags selected from the set of project tags via the user interface; and
to store the one or more selected project tags as at least a portion of the project information in the memory.

The project tags may be defined via the user interface from a sponsor computing device, a user computing device, or a system administrator computing device.

In another embodiment, the processor is configured to receive from the sponsors user group identification information indicative of a group of one or more users.

The group of users may comprise, for example, one or more members, employees or acquaintances of the respective sponsor. For example, if a sponsor wishes to attract a particular group of users (including, for example, its own members, employees or acquaintances, in the case of those sponsors that have members, employees or acquaintances), the sponsor may submit details of that group of users.

The processor may be configured to, when generating respective compatibility scores with respect to a particular sponsor, elevate the project or projects of the user if the user is in a group of users received from the particular sponsor (in some examples to or above the compatibility threshold).

Alternatively, the processor may be configured to present to the user the respective sponsor identification information of any sponsor or sponsors from whom has been received user group identification information indicative of one or more groups of users that include the user, irrespective of whether the compatibility score or scores satisfy the compatibility threshold.

In one embodiment, the system is arranged: to present to the sponsors presented to the user at least some of the personal information and project information of the user via the user interface for sponsor review, and upon receiving a sponsor rejection from one or more of the sponsors, to eliminate either the sponsor or the sponsorship of the sponsor from presentation to the user.

In one example, the processor is configured:
to present a set of predefined project tags to the user via the user interface;
to receive from the user one or more selected project tags selected from the set of project tags via the user interface; and
to store the one or more selected project tags as at least a portion of the project information in the memory;
wherein the set of predefined project tags comprises the respective sponsor identification information (possibly in abbreviated or more concise form) of the sponsor or sponsors from which has been received user group identification information indicative of one or more groups of users that include the user.

This allows a user to use the sponsor identification information as a project tag, and hence to increase or maximize the likelihood (or, in some cases, guarantee) that the sponsor identification information of the corresponding sponsor is presented to the user for user selection or rejection. This also serves to alert the user to the use of the system, as a sponsor, of a party of which he or she is a member or employee, or of a person with which he or she is acquainted.

In a certain embodiment, the processor is configured:
to present a set of predefined sponsorship tags to the one or more sponsors via the user interface;
to receive from the respective sponsors one or more selected sponsorship tags selected from the set of sponsorship tags via the user interface; and
to store the one or more selected sponsorship tags as at least a portion of the target project information or target user information in the memory.

The sponsorship tags may be defined via the user interface from respective sponsor computing devices, a user computing device, or a system administrator computing device.

Comparing the personal information and the project information with the respective target user information and target project information may include comparing the one or more selected project tags and the one or more selected sponsorship tags.

In an embodiment, the processor is configured to receive from the user sponsor group identification information indicative of a group of one or more sponsors.

The group of sponsors may comprise, for example, one or more employers or acquaintances of the user, or organizations of which the user is a supporter or member. For example, if the user wishes to alert particular sponsors to the user's use of the system, as a user.

The processor may be configured to, when generating respective compatibility scores with respect to a particular sponsor, elevate the project or projects of the user if the particular sponsor is in a group of sponsors received from the user (in some examples to or above the compatibility threshold).

Alternatively, the processor may be configured to present to the user the respective sponsor identification information of any sponsor or sponsors identified in the sponsor group identification information, irrespective of whether the compatibility score or scores satisfy the compatibility threshold.

In one example, the processor is configured:
to present a set of predefined sponsorship tags to the one or more sponsors identified by the sponsor group identification information via the user interface;
to receive from the respective sponsors one or more selected sponsorship tags selected from the set of sponsorship tags via the user interface; and
to store the one or more selected sponsorship tags as at least a portion of the target project information or target user information in the memory.
wherein the set of predefined sponsorship tags comprises the user identification information (possibly in abbreviated or more concise form) of the user.

The system may include a user computing device for operation by the user and a sponsor computing device for operation by the sponsor, wherein the user computing device and the sponsor computing device are in data communication with the user interface.

In one embodiment, the user is one of a plurality of users of the system, the memory comprises respective personal information pertaining to the respective users and associated with respective user identification information, and the memory comprises the respective target user information and respective target project information.

The processor may be configured to determine a price for charging the respective sponsor whose sponsorship is selected by the user as a flat fee per project.

Alternatively, the processor may be configured to determine a price for charging the respective sponsor whose sponsorship is selected by the user based on the compatibility score of the selected sponsorship.

The processor may be configured to receive a request from the user or from a sponsor of the user to display a donate button, and to respond by displaying donate button activatable to initiate making of a donation to the user.

According to second broad aspect of the invention, there is provided a computer-implemented method for managing sponsorship, the method comprising:
receiving personal information pertaining to a user and associated with user identification information that identifies the user;
receiving project information pertaining to a project that is associated with the user;
receiving respective target user information indicative of personal characteristics deemed by one or more sponsors to be desirable in a sponsored user, the target user information being associated with respective sponsor identification information that identifies the respective sponsors;
receiving respective target project information indicative of project characteristics deemed desirable in a sponsored project by the respective sponsors;
forming respective comparisons by comparing the personal information and the project information with the respective target user information and target project information;
generating respective compatibility scores from the comparisons, the compatibility scores being indicative of how well matched are the project and the respective sponsorships;
comparing the compatibility scores with a compatibility threshold;
presenting to the user respective the sponsor identification information associated with at least some of the compatibility scores that satisfy the compatibility threshold via a user interface for user selection or rejection; and
receiving from the user either selection or rejection data, the selection data being indicative of at least one selected sponsor or sponsorship, the rejection data being indicative of rejection at least one rejected sponsor or sponsorship.

The method may include presenting to the sponsors associated with the compatibility scores that satisfy the compatibility threshold at least some of the personal information and project information of the user in de-identified form via the user interface for sponsor review, and upon receiving a sponsor rejection from one or more of the sponsors, eliminating either the sponsor or the sponsorship of the sponsor from presentation to the user.

In one embodiment, the method includes identifying the at least one selected sponsor or sponsorship as a sponsor of the user only in response to receiving a user acceptance input from the respective sponsor.

The method may include, upon receiving the data indicative of at least one selected sponsor or sponsorship, associating the at least one selected sponsor as a sponsor of the project of the user.

The method may include: receiving the personal information from the user interface and storing the personal information in a memory of a computing system in association with the user identification information; and receiving the project information from the user interface and either (i) creating the project and storing the project information in the memory in association with the project, or (ii) storing the project information in the memory in association with the project.

In one embodiment, the method includes:
presenting a set of predefined project tags to the user via the user interface;
receiving from the user one or more selected project tags selected from the set of project tags via the user interface; and
storing the one or more selected project tags as at least a portion of the project information in the memory.

In another embodiment, the method includes:
presenting a set of predefined sponsorship tags to the one or more sponsors via the user interface;
receiving from the respective sponsors one or more selected sponsorship tags selected from the set of sponsorship tags via the user interface; and
storing the one or more selected sponsorship tags as at least a portion of the target project information or target user information in a memory.

The step of comparing the personal information and the project information with the respective target user information and target project information may include comparing the one or more selected project tags and the one or more selected sponsorship tags.

In one embodiment, the user is one of a plurality of users of the system, respective personal information pertaining to the respective users and associated with respective user identification information are stored in a memory, and the memory comprises the respective target user information and respective target project information.

The method may include determining a price for charging the respective sponsor whose sponsorship is selected by the user as a flat fee per project.

Alternatively, the method may include determining a price for charging the respective sponsor whose sponsorship is selected by the user based on the compatibility score of the selected sponsorship.

The method may include receiving a request from the user or from a sponsor of the user to display a donate button, and responding by displaying donate button activatable to initiate making of a donation to the user.

According to third broad aspect of the invention, there is provided a computer program comprising instructions that when executed by one or more processors controls a computing device to implement the method described above.

According to fourth broad aspect of the invention, there is provided a computer-readable medium comprising the computer program described above.

It should be noted that any of the various individual features of each of the above aspects of the invention, and any of the various individual features of the embodiments described herein including in the claims, can be combined as suitable and desired.

### BRIEF DESCRIPTION OF THE DRAWINGS

In order that the invention can be more clearly ascertained, embodiments will now be described, by way of example, with reference to the accompanying drawings, in which:

FIG. 1 is a schematic diagram of a system for managing sponsorship according to an embodiment of the present invention;

FIG. 2A is a schematic diagram of the controller and user interface of the server of the system of FIG. 1;

FIG. 2B is a schematic diagram of the controller and user interface of the sponsor computer of the system of FIG. 1;

FIG. 2C is a schematic diagram of the controller and user interface of the user mobile telephone of the system of FIG. 1;

FIG. 3A is a more detailed schematic diagram of the controller and user interface of the server of the system of FIG. 1;

FIG. 3B is a more detailed schematic diagram of the controller and user interface of the sponsor computer of the system of FIG. 1;

FIG. 3C is a more detailed schematic diagram of the controller and user interface of the user mobile telephone of the system of FIG. 1;

FIGS. 4A and 4B constitute a flow diagram of the user registration, journey creation and sponsorship selection process of the system of FIG. 1;

FIG. 5 is a flow diagram of the sponsor registration process of the system of FIG. 1; and

FIG. 6 is a flow diagram of the operation of system of FIG. 1 during the progression of a user's journey.

### DETAILED DESCRIPTION

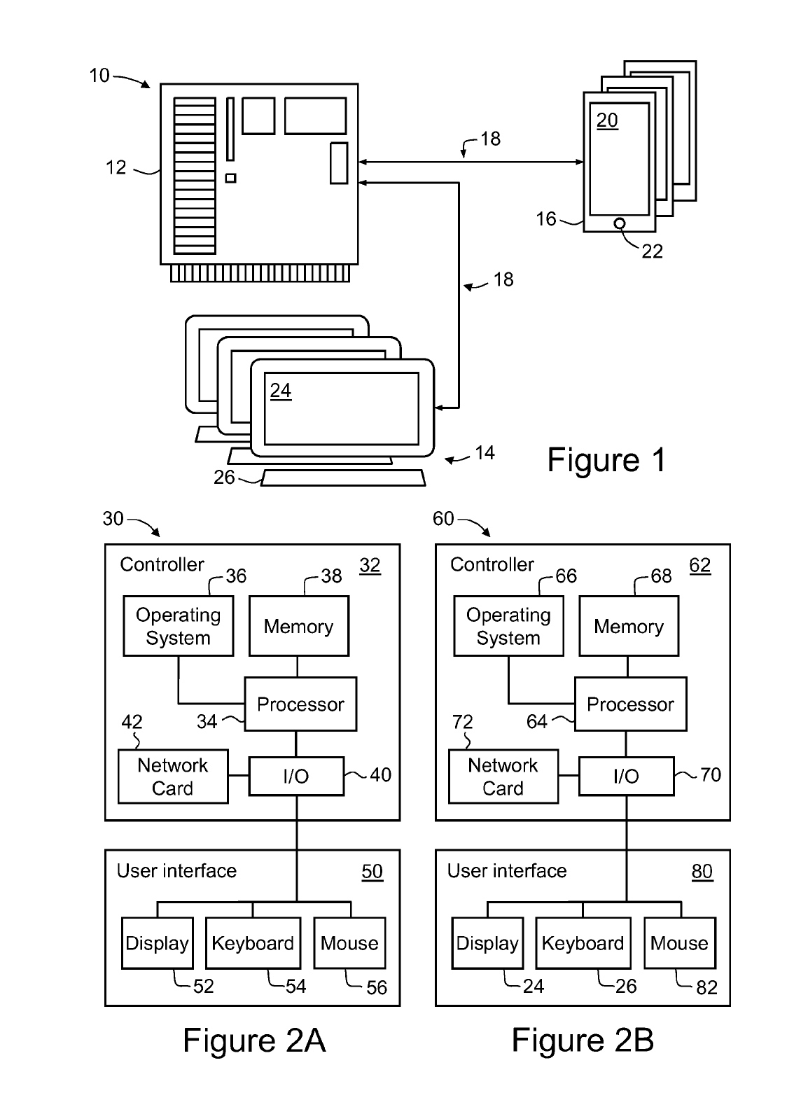

According to an embodiment of the present invention, there is provided a system for managing sponsorship, shown generally at 10 in FIG. 1. In general, system 10 comprises one or more physical or logical computing devices. In this specific embodiment, system 10 is implemented on a computing device in the form of a server 12, on a sponsor computer 14 (of a sponsor) and on a user computing device in the form of, in this embodiment, a mobile telephone 16 (of a user), as—in both cases—a combination of software and hardware. Server 12, sponsor computer 14 and mobile telephone 16 are in data communication 18 via a combination of existing telecommunications infrastructure including a third-party telephony network and the internet.

Broadly, system 10 enables a sponsor (such as a corporation) to sponsor a user (such as an individual) when embarking on a project or ‘journey’. System 10 uses available personal information pertaining to the user (e.g. given name, tag, sex and ‘journey title’) to provide sponsorship to the user in the form of personalised messages of support and encouragement.

Server 12, sponsor computer 14 and mobile telephone 16 have user interfaces, as discussed below. That of mobile telephone 16 includes a touch screen 20 and a control button 22. That of sponsor computer 14 includes a display 24 and a keyboard 26.

It should be understood that system 10 may and typically will include a plurality of sponsor computers 14 of respective sponsors and a plurality of user computing devices 16 of respective users, the actual number of each depending on the number of sponsors and the number of users using system 10 (though it should be noted that a single sponsor may employ plural sponsor computers and, likewise, a single user may employ plural user computing devices). For clarity, however, system 10 will generally be described as though it includes only a single sponsor computer and a single user computing device.

It should also be noted that server 12 includes a website (not shown) that is maintained by an administrator of system 10 on server 12, and which is accessible via the world wide web. As will be explained below, certain content contributed by both the sponsor (via sponsor computer 14) and the user (via mobile telephone 16) is made accessible via this website by server 12.

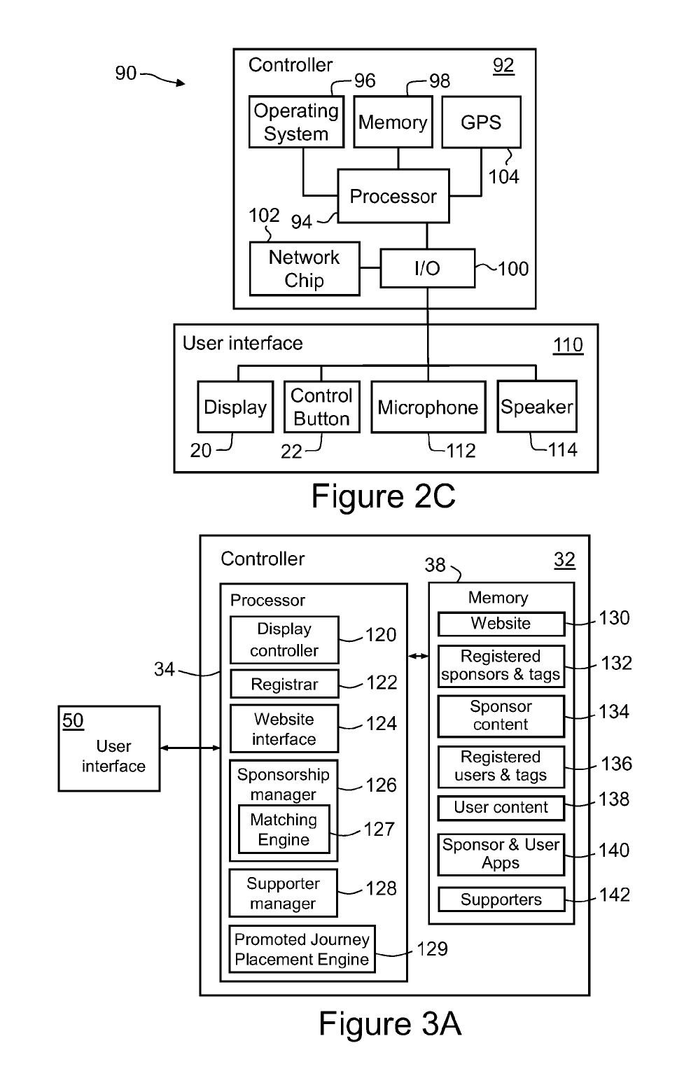

FIG. 2A is a more detailed, schematic block diagram 30 of server 12, in which for clarity only the more important operative components of server 12 are shown. Server 12 includes a controller 32 having a processor 34 and an operating system 36. Instructions and data to control operation of processor 34 are stored in a memory 38, which is in data communication with processor 34. Typically, server 12 includes both volatile and non-volatile memory and more than one of each type of memory, with such memories being collectively represented by memory 38. The website (not shown) is stored in memory 38.

Controller 32 of server 12 has an input/output (I/O) interface 40 for communicating with peripheral devices of system 10. Input/output interface 40, the peripheral devices or both may be intelligent devices with their own memory for storing associated instructions and data for use with the input/output interface 40 or the peripheral devices.

Controller 32 of server 12 includes a communications interface in the form of a network card 42. Network card 42 may be used, for example, to exchange data with sponsor computer 14 and mobile telephone 16, or with the website of system 10 to allow remote interaction with system 10 (as is described below).

In the embodiment shown in FIG. 2A, server 12 includes a user interface 50 that includes peripheral devices that communicate with controller 32 and hence allow an administrator to interact with server 12. User interface 50 is used by an administrator to perform system administrative tasks, and technology support tasks of the server 12 (including controller 32 and included components).

These peripheral devices comprise a display 52, a keyboard 54 and a mouse 56. Additional hardware may be included as part of server 12, or hardware may be omitted as required for the specific implementation.

In this embodiment (and commonly in other embodiments), at least some of the operative components of server 12 are distributed; for example, input/output devices 52, 54 and 56 are typically provided remotely from controller 32.

FIG. 2B is a more detailed, schematic block diagram 60 of sponsor computer 14, in which for clarity only the more important operative components are shown. Sponsor computer 14 includes a controller 62 having a processor 64 and an operating system 66. Instructions and data to control operation of processor 64 are stored in a memory 68, which is in data communication with processor 64. Like server 12, sponsor computer 14 includes both volatile and non-volatile memory, with such memories being collectively represented by memory 68.

Controller 62 of sponsor computer 14 has an input/output (I/O) interface 70 and a communications interface in the form of a network card 72. Network card 72 may be used, for example, to exchange data with server 12 of system 10. Sponsor computer 14 includes a user interface 80 that includes devices that communicate with controller 62 (via I/O interface 70), and hence allow a user to interact with sponsor computer 14. These devices comprise display 24, keyboard 26 and a mouse 82. Additional hardware may be included as part of sponsor computer 14, or hardware may be omitted as required for the specific implementation.

FIG. 2C is a more detailed, schematic block diagram 90 of mobile telephone 16, in which for clarity only the more important operative components are shown. Mobile telephone 16 includes a controller 92 having a processor 94 and an operating system 96. Instructions and data to control operation of processor 94 are stored in a memory 98, which is in data communication with processor 94. Like server 12, mobile telephone 16 includes both volatile and non-volatile memory, with such memories being collectively represented by memory 98.

Controller 92 of mobile telephone 16 has an input/output (I/O) interface 100 and a communications interface in the form of a network chip 102. Network chip 102 may be used, for example, to exchange data with server 12 of system 10. Controller 92 of mobile telephone 16 also includes GPS functionality, and has an antenna suitable for receiving GPS signals and the associated hardware and software for determining the location of the mobile telephone 16 from those signals: these components are shown collectively as “GPS 104”.

Mobile telephone 16 includes a user interface 110 that includes devices that communicate with controller 92 (via I/O interface 100), and hence allow a user to interact with mobile telephone 16. These devices comprise display 20, control button 22, a microphone 112 and a speaker 114. Additional hardware may be included as part of mobile telephone 16, or hardware may be omitted as required for the specific implementation.

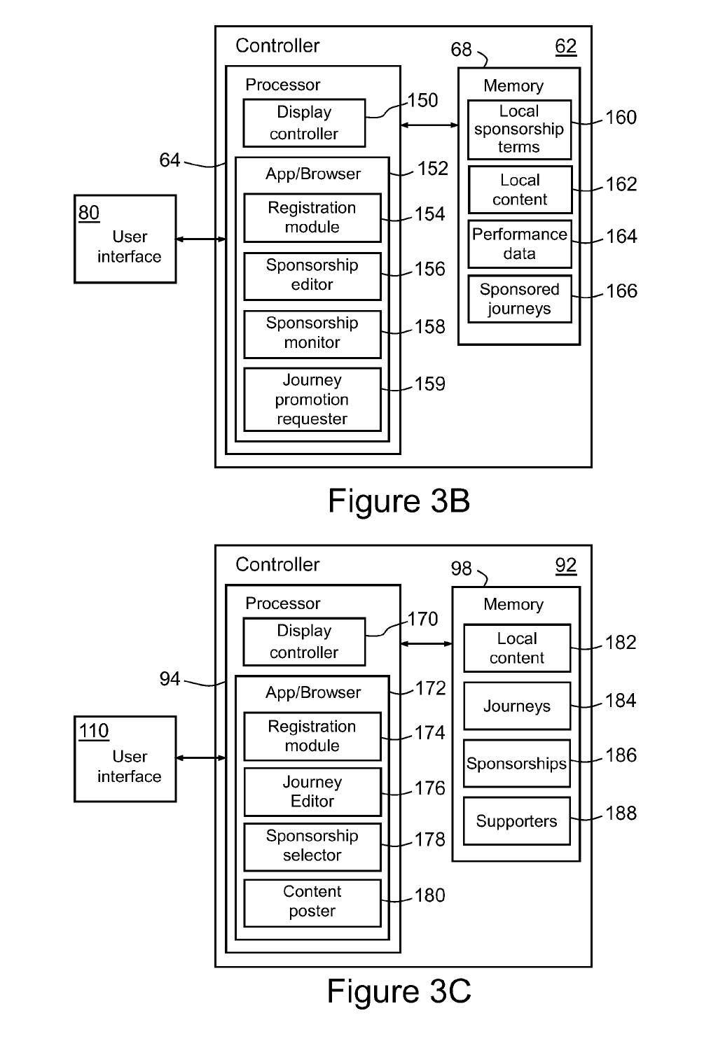

FIG. 3A is another schematic view of the user interface 50 and controller 32 of server 12 of FIG. 2A, with more detail shown in controller 32. Specifically, processor 34 of controller 32 includes a display controller 120 that controls the view that is displayed on display 52 of server 12. Processor 34 also includes a registrar 122 (for managing the registration of sponsors and users) and a website interface 124.

Processor 34 includes a sponsorship manager 126, which includes a matching engine 127. Sponsorship manager 126 acts as a Personal Connection Advertising Engine (PCAE), to facilitate the association of matching users and sponsors but without making the users' personal identification information visible to the sponsors. Processor 34 includes also includes a supporter manager 128 and a promoted journey placement engine 129.

The functions of these components of processor 34 are further described below.

Memory 38 of controller 32 includes a website 130 of system 10, a database of registered sponsors and tags 132, which includes details of each sponsor and of each sponsorship offered by each sponsor, and a database of sponsor content 134. The details of each sponsorship offered by each sponsor are in the form of target user information indicative of the personal characteristics that the respective sponsor regards as desirable in a sponsored user and target journey information indicative of journey characteristics deemed desirable in a sponsored journey by the sponsor. In both cases, this information may be identical for all sponsorships offered by that sponsor (if more than one is offered) or varied according to specific sponsorship; the result is that target user information and target journey information is associated with each sponsorship. The target user information and target journey information are, in this embodiment, stored as tags, based on selections made by or on behalf of the sponsor from menus of predefined options. This can be done when the respective sponsorship is created, and subsequently modified using the same menus. These menus—in the case of the target user information—may include “minimum age”, “maximum age”, “sex”, “occupation”, “income band”, etc, and—in the case of the target journey information—“financial”, “personal improvement”, “home renovation”, “education”, “travel”, etc.

Memory 38 of controller 32 also includes a database of registered users and tags 136, which—for each user-includes personal information, the titles of the user's project(s) or journey(s)′, and journey information pertaining to the respective journeys associated with that user. The personal information is stored as a combination of free fields and tags, based on information entered by or on behalf of the user when the user creates an account with system 10 via website 130, and updated if desired from time to time.

The journey information pertaining to a respective journey that is associated with that user is, in this embodiment, stored as tags the tags are based on selections made by or on behalf of the user from menus of predefined options—which are generally in line with the target journey information menus presented to sponsors. This enables the ready matching of a user's journey information and a sponsor's target journey information.

Memory 38 of controller 32 also includes a database of user content 138, a database of sponsor and user applications 140 (downloadable respectively to sponsor computer 14 and mobile telephone 16), and a supporter database 142. The contents of memory 38 are further described below.

FIG. 3B is another schematic view of the user interface 80 and controller 62 of sponsor computer 14 of FIG. 2B, with more detail shown in controller 62. Specifically, processor 64 of controller 62 includes a display controller 150 that controls the view that is displayed on display 24 of sponsor computer 14. Processor 64 also includes an sponsor application in the form of App 152 (downloaded from sponsor and user applications 140), which itself includes several components including a registration module 154 to allow the sponsor to register as a sponsor with system 10, a sponsorship editor 156 that allows the sponsor to enter and edit the terms of the sponsorship that the sponsor offers to users, a sponsorship monitor 158 that allows the sponsor to inspect the progress, status, supporters, etc, of each user sponsored by that particular sponsor, and a journey promotion requester 159 with which a sponsor can request that a sponsored journey be promoted.

The functionality of App 152 may instead be provided by website 130, and hence accessed via a web browser provided in processor 64 of sponsor computer 14.

Memory 68 of controller 62 of sponsor computer 14 includes a local database of sponsorship terms 160, which can be edited off-line if desired and uploaded to registered sponsors and tags 132 as desired, a local content database 162 where sponsor content can be stored and managed before being uploaded as desired to sponsor content 134, and a performance data database 164 where information concerning sponsored users and supporters (sometimes referred to as ‘followers’) of those sponsored users is stored by sponsorship monitor 158 after being downloaded from server 12. The local content 162 comprises a logo and other graphical and text material that will—in use—be displayed to the user and his or her supporters during a journey of the user that is sponsored by that sponsor.

Memory 68 also includes a database of user ‘journeys’ that are currently being sponsored by the sponsor, including the identity of the specific sponsorship(s) selected by the user(s). However, the user and journey information is de-identified (or anonymized) so that the identity of the sponsored user(s) cannot be accessed by the respective sponsors. Sponsorship monitor 158 can access these details as required.

FIG. 3C is further schematic view of the user interface 110 and controller 92 of mobile telephone 16 of FIG. 2C, with more detail shown in controller 92. Specifically, processor 94 of controller 92 includes a display controller 170 that controls the view that is displayed on display 20 of mobile telephone 16. Processor 94 also includes a user application in the form of App 172 (downloaded from sponsor and user applications 140), which includes several components including a registration module 174 to allow the user to register with system 10, a journey editor 176 to allow the user to create and edit journeys, including adding tags to each journey in order to characterize that journey, a sponsorship selector 178 to allow the user to select the sponsorship of a sponsor for each journey, and a content poster 180 that allows the user to post content to each journey for display on website 130. The functionality of App 172 may instead be provided by website 130, and hence accessed via a web browser provided in processor 94 of mobile telephone 16.

Memory 98 of controller 92 of mobile telephone 16 includes a local content database 182 where user's content can be stored and managed before being uploaded—as desired—to user content 138, a database of journeys 184 (which includes the title of each journey as nominated by the user and the tags associated with each journey by the user), a database of sponsorships 186 where the user's sponsorships are recorded (each identified by the respective journey of the user to which the sponsorship is attached, as each user may have a plurality of such journeys), and a database of supporters 188 where the respective user's supporters are recorded (each also identified by the respective journey of the user that is being supported by the respective supporter).

The operation of system 10 will now be explained by reference to the various functions implemented by the above-described components thereof.

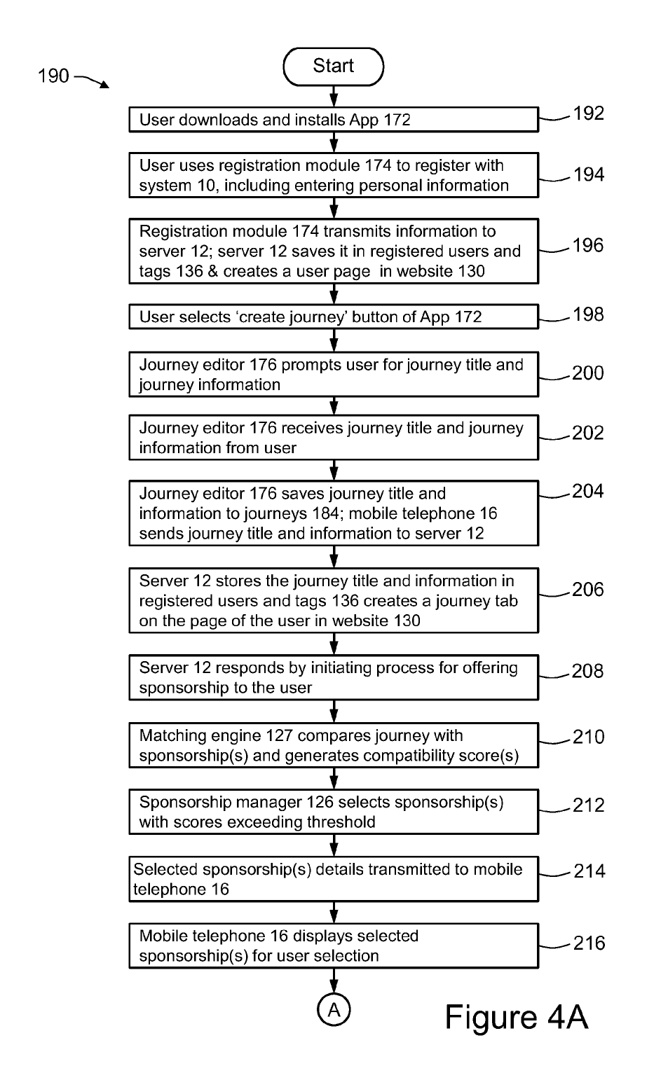

FIGS. 4A and 4B is a flow diagram 190 of the user registration, journey creation and sponsorship selection process of system 10 of FIG. 1. Referring to FIG. 4, at 192 a user downloads to mobile telephone 16 and installs App 172 from website 130 of server 12 (via website interface 124). At step 194, the user employs registration module 174 to register with system 10, as follows: registration module 174 prompts the user for personal information, including given name, sex, email address, etc. At step 196, App 172 controls mobile telephone 16 to send this personal information to server 12, server 12 stores the information in registered users and tags 136, and server 12 creates a page for the (now registered) user in website 130. The user is now registered as a user with system 10, and may be regarded as a member.

A user may be a member or account holder with system 10 without creating a journey, but—if the now registered user wishes to create a journey—he or she, at step 198, selects a ‘create journey’ button displayed by App 172. This prompts App 172 to control journey editor 176 to prompt the user, at step 200, to enter a title for the journey and to prompt the user for journey information, in the latter case by prompting the user to select one or more tags from a menu of predefined tags to characterize the journey. The journey information may include sponsor exclusions, should the user wish to pre-empt any possibility of being offered sponsorship by a particular class of sponsor. For example, a user may select—from a pull-down menu of sponsors' fields of activity—‘alcohol’ as a sponsor exclusion. This makes all sponsorships provided by sponsors in the field of the preparation or sale of alcoholic beverages deemed unavailable, either for association with that user or with the immediate journey (at the election of the user).

At step 202, journey editor 176 receives the requested information from the user and, in response, at step 204 journey editor 176 saves the journey title and information to journeys database 184 and App 172 controls mobile telephone 16 to send the journey title and information to server 12. At step 206, server 12 stores the journey title and journey information in registered users and tags 136 (associated with the relevant user) and creates a journey tab or page (referred to as a ‘Journeyboard’) for that journey, named after the journey title, on the page of the user in website 130. Initially that tab—though viewable by an another registered user or an external user-will contain only the user's name and the journey title.

At step 208, server 12 responds to the creation of a journey by controlling sponsorship manager 126 to initiate the process by which sponsorship for that journey is offered to the user.

At step 210, matching engine 127 of sponsorship manager 126 accesses and compares the personal information (of the user) and the journey information (of the journey) with the target user information and the target journey information of each available sponsorship and generating a compatibility score from the comparison for each available sponsorship, the compatibility score being indicative of how well matched are the journey and the respective sponsorship. Matching engine 127 employs, in this embodiment, fuzzy logic and heuristic analysis techniques when conducting this comparison so that the resulting compatibility score is greatest for user/sponsorship combinations regarded by the system administrator as optimal, principally from the perspective of the sponsors; hence, the rules embedded in and employed by matching engine 127 for making these comparisons are tunable by the system administrator in order to optimize the outcome and hence match each sponsorship to the journey(s) of greatest value to the respective sponsors.

This step will generally result in the generation of as many compatibility scores as there are available sponsorships. (In some embodiments, certain information may be used to veto certain journey/sponsorship or user/sponsorship combinations as unsuitable before a compatibility score is generated. For example, certain goods or services offered by a sponsor may be inappropriate for minors, so a sponsor may set an ‘Age Gate’ to prevent their sponsorships being offered to minors. These ‘sponsor exclusions’ have the effect of making such sponsorships ‘unavailable’ for that journey.)

The comparison may be performed and the compatibility scores generated in any reasonable manner. Generally, certain characteristics will be regarded as of low importance to a sponsor—and can be flagged as such when they are selected at the creation of a sponsorship. For example, some services provided by a sponsor (such financial services) may be directed to both sexes, so the sex of the user will not be selected as a criterion when the sponsorship is created. However, other services (such as ‘facials’)—though not exclusively for one sex—may be predominantly used by one sex. In this example, when a provider of such services selects target journey information, it would select ‘female’ as the preferred sex and, optionally, weight that criterion as ‘high’ or ‘very high’. Certain age groups or income ranges may also be regarded as especially desirable to a sponsor, which would accordingly weight those criteria as ‘high’ or ‘very high’.

Other characteristics may be treated as absolute, and weighted as ‘fixed’. In other words, if the sponsor selects ‘financial’ as the type of journey they wish to sponsor, that sponsor may, optionally, flag that characteristic as ‘fixed’—which would result in a vetoing of sponsorship of any journeys that are not described by the user as ‘financial.’ (Indeed, doing so may result in that sponsorship being deemed unavailable for non-financial journeys, as described above.)

All these factors are employed by matching engine in generating compatibility scores.

At step 212, sponsorship manager 126 compares the compatibility scores of the sponsorships with a compatibility threshold and selects only those sponsorships that satisfy that compatibility threshold (in this embodiment, exceed the threshold). The compatibility threshold may be predefined (say, 75%) or determined dynamically using algorithms applied to target and/or sponsor information.

At step 214, sponsorship manager 126 controls server 12 to transmit the selected sponsorships (and associated details) to mobile telephone 16. At step 216, sponsorship selector 178 displays details—including the identity of each sponsor—of the selected sponsorship(s) to the user on display 20 for user selection. At step 218, the user controls sponsorship selector 178 to select one of the displayed sponsorship(s) (or to select ‘opt out’ of sponsorship, discussed below). (In an alternative embodiment, sponsorship selector 178 displays the details of only one sponsorship—that with the highest compatibility score—to the user on display 20 for user approval, and if the user rejects the displayed sponsorship, sponsorship selector 178 displays the details of the sponsorship with the next highest compatibility score, and so on until a sponsor/sponsorship is selected. If none are selected, sponsorship is deemed to have opted-out of sponsorship.) If the user selects one of one of the displayed sponsorship(s), at step 220, sponsorship selector 178 responds by saving the selected sponsorship to sponsorships 186 and controlling mobile telephone 16 to transmit the identity of the user and selected sponsorship to server 12, and de-identified information concerning the user and the journey to sponsor computer 14.

(In this embodiment, the user may select only one sponsorship per journey, but in another embodiment the user may select a plurality of sponsorships (if a plurality have satisfied the threshold at step 212); if so, sponsorship selector 178 saves the selected sponsorships to sponsorships 186 and controls mobile telephone 16 to transmit the identity of the user and selected sponsorships to server 12, and de-identified information concerning the user and the journey to the respective sponsor computers 14, if more than one sponsor is associated with the selected sponsorships.)

At step 222, server 12 and sponsor computer 14 update—respectively—registered users and tags 136 and sponsored journeys 166. In the former case, this involves amending the record of the user to indicate that the user is now sponsored with the selected sponsorship(s) of the corresponding sponsor(s); in the latter instance, sponsorship monitor 158 updates sponsored journeys 166. Processing then ends.

It will be noted that the sponsor does not control who selects their sponsorship (provided that the sponsorship matches the journey to an acceptable degree). However, optionally, server 12 may provide de-identified information to sponsors that will enable them to target their sponsorships not only on journey tags/categories of the journey but based on other journeys the individual user is making (even if the sponsor does not want to sponsor those journeys). For example, a bank may be interested in Finance journeys but particularly so if the user is also on a “getting married” journey (as the user may be more likely to desire a home loan).

As described above, there may be more than one sponsor per journey. However, sponsorship selector 178 may alternatively be configured to allow the user to select only one sponsor from the displayed matching sponsors for any particular journey, such that there can be at most one sponsor per journey.

It should also be noted that, once a journey has been created, the user can also use journey editor 176 to edit the journey (should its characteristics or title require refinement) or flag the journey as completed—which also has the effect of terminating any sponsorships of that journey. This includes the option of adding a “donate” button to the journey. The “donate” button, if selected by the user using journey editor 176, is then added by journey editor 176 to the journey. The “donate” button encourages the general public to donate to the user; if activated (such as by a supporter), system 10 responds by facilitating payment (by conventional means) of a donation to the user.

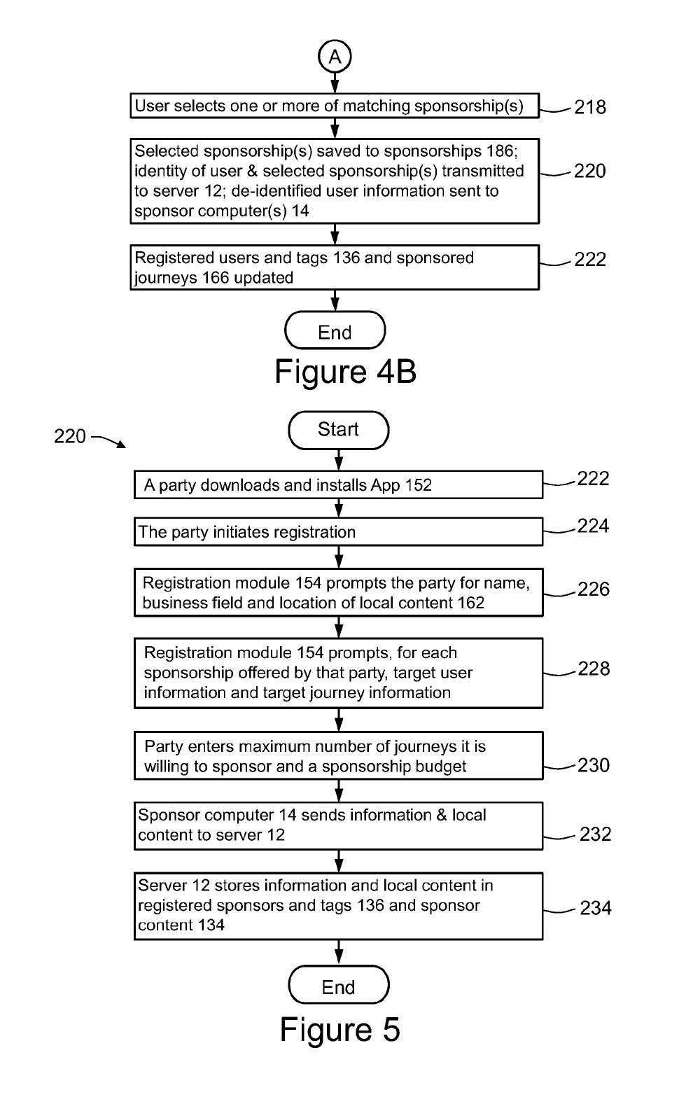

FIG. 5 is a flow diagram 220 of the sponsor registration process of system 10 of FIG. 1. Referring to FIG. 5, at 222 the party that wishes to become a sponsor (in this embodiment assumed to be a corporate entity) downloads App 152 from website 130 of server 12 (via website interface 124) to sponsor computer 14 and installs App 152. At step 224, that party controls registration module 154 to initiate registration as a sponsor with system 10. At step 226, registration module 154 responds by prompting the party for name, business field and location of local content 162, which the party does, and at step 228, to enter details of each sponsorship offered by that party in the form of the target user information and the target journey information, which is entered also as described above. This information, which the party enters and/or selects, constitute the detailed selection criteria to be used by matching engine 127. In this step, the party may be displayed one or more default selection criteria, so selection may be in the form of accepting at least some of these default values.

Also, the party may create a plurality of combinations of selection criteria (that is, sets of target user information and target journey information) allows the prospective sponsor to target different ideal user/journey combinations without increasing the number of sponsorships being offered. The party may also offer a plurality of sponsorships, which may have the same or different sets of target user information and target journey information, but doing so should be distinguished from offering—say-one sponsorship associated with plural sets of target user information and target journey information.

At step 230, that party selects or enters the maximum number of journeys it is willing to sponsor (which may be entered as an overall value or separate values for each type of sponsorship that party is offering) and the sponsorship budget (with payments to be made automatically by conventional techniques when a sponsorship is selected by a user for a journey). System 10 bills a flat fee per journey, currently set at $1. It is envisaged that this flat fee will be charged to each sponsor irrespective of length and quality of the journey and irrespective of how many events occur on the journey. However, billing may alternatively be based on, for example, the number of events that occur in a journey, the number of journey supporters, or otherwise. In one alternative billing approach, the fee per journey is based on the compatibility score of the selected sponsorship; for example, a 99% score might command a fee per journey 3x the base rate, a 85% score 2× the base rate, and so forth.

Once this information has been entered, at step 232 App 152 controls sponsor computer 14 to send this information and local content to server 12, where—at step 234—server 12 stores it in registered sponsors and tags 136 and sponsor content 134 (identified by sponsor). The party is now registered with system 10 as a sponsor.

In an alternative sponsor registration technique, the required information and content is provided by the sponsor to the administrator of system 10 by any other convenient means, and the administrator of system 10 uses registrar 122 to enter the required information and content into registered sponsors and tags 136 and sponsor content 134 of server 12. Processing then ends.

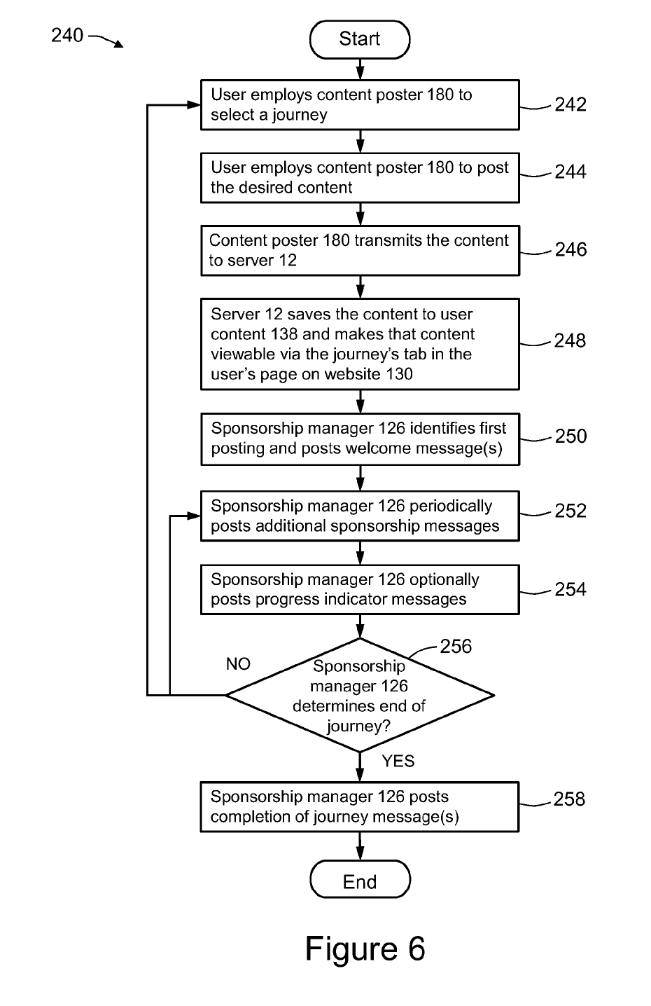

FIG. 6 is a flow diagram 240 of the operation of system 10 during the progression of a user's journey (created previously as explained by reference to FIG. 4). A journey may comprise any project of a user that involves a sequence of steps executed over time. A typical journey might thus comprise travel, construction of a home, a handyman project, a relationship, a money-saving plan, a weight-loss program or an academic course.

At step 242, the user employs content poster 180 to select a journey of that user and to post content to that journey. The content may be a text message or other content (graphical, audio or video) stored previously by the user in local content 182. At step 244, the user employs content poster 180 to post the desired content and, in response, content poster 180 transmits the content to server 12 at step 246. Server 12, at step 248, saves the content that it has received from content poster 180 to user content 138 and makes that content viewable when another registered user or an external user next visits this journey's tab in the user's page on website 130.

Steps 242 to 248 can be repeated as often as desired by the user as the journey progresses. However, at step 250 after the first instance of the posting of content for a particular journey, sponsorship manager 126 of server 12—identifies that the posting is the first for the journey, so deeming this event to be the commencement of the journey—responds by posting the welcome message(s) of the sponsor(s), previously stored in sponsor content 134 by the respective sponsors. The welcome message(s) also appear, therefore, on that journey's page. For example, a welcome message may comprise a corporate logo or banner of the sponsor and words appropriate for the user (e.g. “Michael”) and the type of sponsorship (e.g. a campaign title of a promotional campaign of the sponsor of which the sponsorship is a part), such as:
Michael, good luck on your journey!
New digs #port Melbourne
[corporate logo of sponsor]

Periodically, shown at exemplary step 252, additional messages of support are posted by sponsorship manager 126 of server 12 on behalf of the sponsor. The Information used to generate the welcome message would typically comprise the given name and sex of the user, the journey title (e.g. New digs #portmelb), the campaign title (e.g. “Buy Ready”), a support icon (intended to communicate the sponsor's support of the journey), a sponsor logo and the sponsor's preferred colour(s).

In addition to facilitating the posting of a welcome message and any additional messages of support, sponsorship manager 126 may also be controlled by sponsorship editor 156 (under sponsor control) to display a “donate” button. If the sponsor uses sponsorship editor 156 to add a “donate” button to a particular sponsorship (whether before or after the sponsorship is selected by the user), sponsorship manager 126 of server 12 posts the “donate” button, either—at the election of the sponsor—as a part of the welcome message or as (or accompanying) an additional message of support. The “donate” button encourages the general public to donate to the user; if activated (such as by a supporter), system 10 responds by facilitating payment (by conventional means) of a donation to the user.

Sponsorship manager 126 of server 12, as shown at exemplary step 254, also draws on the same information periodically to generate a personalised automated progress indicator that illustrates visually how far through the journey the user has progressed. This progress indicator is intended to assist the user in tracking progress. The user, when creating the journey with journey editor 176, can choose to activate this progress indicator functionality and to select how long the journey is to last and with what frequency a progress indicator should be displayed (e.g. as each third or quarter of the journey is passed).

Thus, if the user activates the progress indicator functionality, selects a journey time of a year and a progress indicator frequency of each third of the journey, a message will be displayed once a third of the year has passed (such as “Congratulations, Sarah, you are 33% through your journey!”) and another message will be displayed once a further third of the year has passed (such as “Congratulations, Sarah, you are 67% through your journey!”).

At step 256 sponsorship manager 126 of server 12 determines whether the journey has been completed, such as because the user-entered journey duration (as described above) has passed or because the user has manually terminates the journey. If the journey is not completed, processing returns to step 242 or 248, where the user or sponsorship manager 126 posts further messages. Otherwise, if the journey is determined to have been completed, processing continues at step 258 where sponsorship manager 126 posts a completion of a journey message or messages, according to the number of sponsorships, again drawing on the information listed above. Such a message might read: “Sam, congratulations on completing your journey!” accompanied by corporate logo, etc. Processing then ends.

System 10 includes various other features. Website 130 provides a facility to permit other registered users to support a journey of a user. When such a user selects the support control on a specific journey, that other user is registered as a supporter by supporter manager 128 in supporter database 142 in memory 38 of server 12. The details of the supporters of a particular journey of a respective user are also transmitted to that user's mobile telephone 16 and stored in supporters database 188. Those supporters may themselves post comments for display to the journey's page, and their images—if posted (which will typically be so for registered users)—are displayed in a Support Centre tab of the journey's page. The logo of the sponsor is also displayed in the Support Centre. As the number of supporters increases, the sponsor's logo may be kept located in the fixed place—determined either relative to the screen or relative to the images of other registered users.

In addition, sponsorship manager 126 periodically transmits to sponsor computer 14 data concerning the number of views of each sponsored journey's page, so that the sponsor can assess the value of the sponsorship. This data is received by sponsorship monitor 158 and stored in performance data 164, and may be viewed and interrogated by the sponsor by operating sponsorship monitor 158.

Also, a user can opt out of sponsorship by paying system 10 a fee, which is set at the same rate the sponsors are charged. Opting out of sponsorship removes any sponsorship events from occurring.

Typically, a user will post a picture for display on a journey page and designated as that journey's “Profile Picture.” Once a sponsorship has been added to the journey, sponsorship manager 126 can superimpose a sponsor's banner (personalised with the user's first name and the sponsor's campaign title) on that Profile Picture (such as along the top or bottom edge), so that Profile Picture combines the user and sponsor content. The resulting Profile Picture visually connects the sponsor to the journey.

Server 12 also supports promoted journeys, which are managed by promoted journey placement engine 129. Promoted journey placement engine 129 is remotely controllable via user interface 80 of sponsor computer 14 to create and control certain aspects of a promoted journey.

As a result, the promoted journey gives the sponsor the ability to feature a promoted journeymaker (viz. a registered user with a journey) on an inspiring or otherwise interesting journey. A promoted journey is featured to give it more prominence and hence gain it (and its sponsor's advertising or other displayed material) more attention. Unlike a sponsored but unpromoted journey, the sponsor—using promoted journey placement engine 129—can control all posts on the journey's Journeyboard to enable carefully controlled context.

The sponsor, from user interface 80 of sponsor computer 14, controls journey promotion requester 159 to submit a request to promoted journey placement engine 129 to promote a specific journey sponsored by that sponsor. This prompts promoted journey placement engine 129 to mark that journey as promoted, and to control server 12 to bill the sponsor a greater amount (e.g. 2× or 3× the currently applicable rate) for that journey.

Promoted journeys are promoted to other registered users and visitors (i.e. external users) at various promotion points, including website 130, as posts on Journeyboards, and as Promoted Journeyboxes on the user's page. This helps increase the volume of supporters sharing the promoted journey.

Finally, tables 1 to 3 summarize the elements of the basic model of this embodiment, which has three facets: the registered user (and in particular his or her mobile telephone 16), server 12 (or more specifically sponsorship manager (or PCAE) 126), and the sponsor (and in particular sponsor computer 14).

TABLE 1
Registered Users

REGISTERED USERS
Journey Specific
Personal Identification
Information (PII) Attributes -
journey specific
Journey Specific Content
Non-PII attributes
User designated Sponsor
exclusions/limitations
Sponsor acceptance
User Home Page
PII attributes, System-wide
Non-PII attributes, System-wide

TABLE 2
PCAE

Personal Connection Advertising Engine (PCAE): provides
personalisation with no visibility to Personal Identification Information
(PII) to sponsors
The PCAE anonymously combines sensitive user and sponsor
information behind a firewall-like barrier to create targeted, relevant,
context sensitive sponsorship (and hence advertising) placement with
registered users, the advertising being embedded in user content -
persistent, dynamic, durable and focused advertisement placements
Matching Rules Engine:
Tags + PII + non-PII + user exclusions => Sponsor compatibility score
Uses fuzzy logic and heuristic analysis techniques to optimise matches
Sponsor Ranking, Bidding, and Selection Engine - picks Sponsor for
each new Journey
Ranks each sponsor passing the basic criteria vs other sponsors and
sponsor criteria
Applies Sponsor bid criteria and premium settings/rankings and prices
the sponsorship
Auto/manual acceptance by Sponsor (depending on thresholds)
uses fuzzy logic and heuristic analysis techniques to drive selection
analytics
Sponsor Appointment Engine:
Manages, resolves “inappropriate matches” due to sponsor or user
criteria
Manages rejection of sponsorship by sponsor
Presents one or more sponsors to user, with sponsor name, icon &
sponsor introductory text for user to accept/choose the sponsor for their
journey, or opt out of sponsorship (for a “sponsor free” journey)
Sponsorship/Promoted Journey Price Computation Engine:
computes price to sponsor a specific journey based on match ranking
and sponsor weights & wallet limits; computes
computes price to place a promoted journey on registered user's home
based on criteria home based on match ranking and sponsor weights &
wallet limit
Dynamic content delivery engine - delivers sponsor content to user with a
journey including
sponsor tailored message content, personalised, words, icons, images
places content per dynamic business rules based on brokering
preferences/payment level of sponsors and end users sponsor
management criteria (within overall system boundaries
choice of triggers based on Journey Specific information
standard and sponsor configured trigger and content “packages”
provided to drive content
placement of sponsor content based on dynamic and journey specific
attributes
Promoted Journey Placement Engine - matches System-wide user info
(PII and non PII) with sponsor target criteria to select user candidates for
each specific promoted journey
leverages Matching, Sponsor Ranking, Conflict Resolution, Price
Computation engines to select registered users (no PII transferred to
Sponsor) to receive the Sponsor's promoted journey on their home page
(and where it is positioned)
Reports to sponsor on number and quality of matches for the promoted
journey, and allows authorisation or modification of selections offered.

TABLE 3
Sponsors

Sponsor (a.k.a. TSOM: The Sponsor of Me ™)
TSOM target criteria: PII, Non PII, Journey
Specific tags, Premium criteria and weights
TSOM tailored message content configuration:
phrases, triggers, images, placement
Journey acceptance criteria and approval
thresholds
Wallet management - manual acceptance,
automated approval parameters, daily/frequency
other limiting cost or volume parameters
Promoted Journey criteria and
Promoted Journey content

Table 4 is a more comprehensive summary of the information about a user that is making a journey that either the user is prompted for when registering with system 10 and when creating his or her journey, or which is determined by the server 12.

TABLE 4
User information

| | JOURNEY |
|---|---|
| INFORMATION | SPECIFIC? |
| first name & sex | NO |
| location of user | NO |
| other registration details | NO |
| number of unique system supporters of the user | NO |
| (determined and regularly updated by server 12) | |
| sponsor exclusions set by user | YES or NO |
| number of other journeys and tags on those journeys | NO |
| count by sponsor of users other current journeys | NO |
| (determined and regularly updated by sponsorship | |
| manager 126) | |
| journey title | YES |
| journey description | YES |
| location of journey | YES |
| journey tags selected (topic, subtopic, sub-sub) | YES |

Table 5 contains a more comprehensive summary of the data flow from a user with a journey to server 12 and of the data flow from server 12 to a user with a journey.

TABLE 5
Data Flow from User to Server and Server to User

| USER TO SERVER | SERVER TO USER |
|---|---|
| Journey specific and system- | Notice of sponsor selected or “select |
| wide attribute | your sponsor” information |
| Personal identification | Placement of sponsor content in the |
| information and other | user's journey per the user and sponsor |
| | criteria in the Sponsorship Manager |
| Sponsor limitations, rejection | Tailored, personalised messages of |
| criteria and specific sponsor | support, awards, recognition from sponsor |
| selection/rejection | to user as posts, banners, icons, etc. |
| | Tailored placement of sponsor content |
| | Promoted Journeys placed on homepage |

Table 6 is a more comprehensive summary of the data flow from a sponsor to server 12 and of the data flow from system 10 to a sponsor.

TABLE 6
Data Flow from Sponsor to Server and Server to Sponsor

| SPONSOR TO SERVER | SERVER TO SPONSOR |
|---|---|
| Personal identification information | Report (without any identifiable |
| target criteria (i.e. target user | personal identification information) |
| information) | of user rejected sponsorship with |
| | reason code |
| Additional target criteria (i.e. target | Report of match score & ranking |
| project information), premium | for journeys they are placed as |
| factors, and priority of criteria | sponsors for |
| Bidding instructions, limits and | Report of page views on their |
| controls, including parameter than | sponsored journeys |
| required manual approval | |
| Response for manual approval | “Reach” report of unique |
| request | supporters per journey |
| Target criteria based on site-wide | Report of current active sponsored |
| user characteristics for promoted | journeys |
| journey placement | |
| Message and content tailoring | |
| (words, icons, images), frequency, | |
| trigger instructions (default or | |
| journey), and placement instructions; | |
| includes tailored “pick me” message | |
| content | |
| Promoted journey content | |

Table 7 contains a more comprehensive summary of the sponsor inputs.

TABLE 7
Sponsor Inputs

SPONSOR INPUTS
Personal identification information target criteria, journey
specific and system-wide
Other criteria (e.g. journey specific tags/sub-tags)
User exclusions (e.g. none <18 years old)
Premium criteria (what will pay extra for) e.g. number of
supporters, type of journey, or user)
Priority setting/weighting of all criteria
Bidding, approval, payment controls and limits (e.g. per
journey limit, journeys total or per day limit), wallet limit
Target criteria and priorities for promoted journey content

Finally, it should be understood to those persons skilled in the art of the invention that many modifications may be made without departing from the spirit and scope of the invention. It should also be understood that the reference to any prior art in this specification is not, and should not be taken as an acknowledgement or any form of suggestion that such prior art forms part of the common general knowledge in any country.

In the claims which support and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A system for managing sponsorship of users by sponsors, comprising:
a computing system comprising a user interface and a controller having a processor, an operating system and a memory;
wherein the processor is configured:
to receive personal information pertaining to a user and associated with user identification information that identifies the user;
to receive project information pertaining to a project that is associated with the user;
to receive respective target user information indicative of personal characteristics deemed by one or more sponsors to be desirable in a sponsored user, the target user information being associated with respective sponsor identification information that identifies the respective sponsor;
to receive respective target project information indicative of project characteristics deemed desirable in a sponsored project by the respective sponsors;
to form respective comparisons by comparing the personal information and the project information with the respective target user information and target project information;
to generate respective compatibility scores from the comparisons, the compatibility scores being indicative of how well matched are the project and the respective sponsorships;
to compare the compatibility scores with a predefined compatibility threshold;
to present to the user the respective sponsor identification information associated with at least some of the compatibility scores that satisfy the compatibility threshold via the user interface for user selection or rejection; and
to receive from the user either selection or rejection data, said selection data being indicative of at least one selected sponsor or sponsorship, said rejection data being indicative of rejection at least one rejected sponsor or sponsorship.

2. A system as claimed in claim 1, arranged to present to the sponsors associated with the compatibility scores that satisfy the compatibility threshold at least some of the personal information and project information of the user in de-identified form via the user interface for sponsor review, and upon receiving a sponsor rejection from one or more of said sponsors, to eliminate either said sponsor or the sponsorship of said sponsor from presentation to the user.

3. A system as claimed in claim 1, wherein the processor is configured:
i) to identify the at least one selected sponsor or sponsorship as a sponsor of the user only in response to receiving a user acceptance input from the respective sponsor; and/or
ii) upon receiving the data indicative of at least one selected sponsor or sponsorship, to associate the at least one selected sponsor as a sponsor of the project of the user.

4. (canceled)

5. A system as claimed in claim 1, arranged:
to receive the personal information from the user interface and to store the personal information in the memory in association with the user identification information; and
to receive the project information from the user interface and either (i) to create the project and store the project information in the memory in association with the project, or (ii) to store the project information in the memory in association with the project.

6. A system as claimed in claim 1, wherein the processor is configured:
to present a set of predefined project tags to the user via the user interface;
to receive from the user one or more selected project tags selected from the set of project tags via the user interface; and
to store the one or more selected project tags as at least a portion of the project information in the memory.

7. (canceled)

8. A system as claimed in claim 1, wherein the processor is configured to receive from the sponsors user group identification information indicative of a group of one or more users.

9-11. (canceled)

12. A system as claimed in claim 1, wherein the processor is configured:
to present a set of predefined sponsorship tags to the one or more sponsors via the user interface;
to receive from the respective sponsors one or more selected sponsorship tags selected from the set of sponsorship tags via the user interface; and
to store the one or more selected sponsorship tags as at least a portion of the target project information or target user information in the memory.

13. (canceled)

14. A system as claimed in claim 1, wherein comparing the personal information and the project information with the respective target user information and target project information includes comparing the one or more selected project tags and the one or more selected sponsorship tags.

15-19. (canceled)

20. A system as claimed in claim 1, wherein:
the user is one of a plurality of users of the system;
the memory comprises respective personal information pertaining to the respective users and associated with respective user identification information; and
the memory comprises the respective target user information and respective target project information.

21. A system as claimed in claim 1, wherein the processor is configured to receive a request from the user or from a sponsor of the user to display a donate button, and to respond by displaying donate button activatable to initiate making of a donation to the user.

22. A computer-implemented method for managing sponsorship, the method comprising:
receiving personal information pertaining to a user and associated with user identification information that identifies the user;
receiving project information pertaining to a project that is associated with the user;
receiving respective target user information indicative of personal characteristics deemed by one or more sponsors to be desirable in a sponsored user, the target user information being associated with respective sponsor identification information that identifies the respective sponsors;
receiving respective target project information indicative of project characteristics deemed desirable in a sponsored project by the respective sponsors;
forming respective comparisons by comparing the personal information and the project information with the respective target user information and target project information;
generating respective compatibility scores from the comparisons, the compatibility scores being indicative of how well matched are the project and the respective sponsorships;
comparing the compatibility scores with a predefined compatibility threshold;
presenting to the user respective the sponsor identification information associated with at least some of the compatibility scores that satisfy the compatibility threshold via a user interface for user selection or rejection; and
receiving from the user either selection or rejection data, said selection data being indicative of at least one selected sponsor or sponsorship, said rejection data being indicative of rejection at least one rejected sponsor or sponsorship.

23. A computer-implemented method as claimed in claim 22, including presenting to the sponsors associated with the compatibility scores that satisfy the compatibility threshold at least some of the personal information and project information of the user in de-identified form via the user interface for sponsor review, and upon receiving a sponsor rejection from one or more of said sponsors, eliminating either said sponsor or the sponsorship of said sponsor from presentation to the user.

24. A computer-implemented method as claimed in claim 22, wherein the method includes: (i) identifying the at least one selected sponsor or sponsorship as a sponsor of the user only in response to receiving a user acceptance input from the respective sponsor; and/or (ii) upon receiving the data indicative of at least one selected sponsor or sponsorship, associating the at least one selected sponsor as a sponsor of the project of the user.

25. (canceled)

26. A computer-implemented method as claimed in claim 22, including:
receiving the personal information from the user interface and storing the personal information in a memory of a computing system in association with the user identification information; and
receiving the project information from the user interface and either (i) creating the project and storing the project information in the memory in association with the project, or (ii) storing the project information in the memory in association with the project.

27. A computer-implemented method as claimed in claim 22, including:
presenting a set of predefined project tags to the user via the user interface;
receiving from the user one or more selected project tags selected from the set of project tags via the user interface; and
storing the one or more selected project tags as at least a portion of the project information in the memory.

28. (canceled)

29. A computer-implemented method as claimed in claim 22, including:
presenting a set of predefined sponsorship tags to the one or more sponsors via the user interface;
receiving from the respective sponsors one or more selected sponsorship tags selected from the set of sponsorship tags via the user interface; and
storing the one or more selected sponsorship tags as at least a portion of the target project information or target user information in a memory.

30. (canceled)

31. A computer-implemented method as claimed in claim 22, wherein comparing the personal information and the project information with the respective target user information and target project information includes comparing the one or more selected project tags and the one or more selected sponsorship tags.

32. A computer-implemented method as claimed in claim 22, wherein:
the user is one of a plurality of users of the system;
respective personal information pertaining to the respective users and associated with respective user identification information are stored in a memory; and
the memory comprises the respective target user information and respective target project information.

33. A computer-implemented method as claimed in claim 22, including receiving a request from the user or from a sponsor of the user to display a donate button, and responding by displaying donate button activatable to initiate making of a donation to the user.

34. A computer program or computer-readable medium comprising instructions that when executed by one or processors controls a computing device to implement the method of claim 22.

35. (canceled)
